(19) United States
(12) Patent Application Publication
(10) Pub. No.: US 2025/0370644 A1
(43) Pub. Date: Dec. 4, 2025

(54) CONTROLLER, MEMORY SYSTEM INCLUDING CONTROLLER, AND METHOD OF OPERATING MEMORY SYSTEM

(71) Applicant: SK hynix Inc., Gyeonggi-do (KR)

(72) Inventors: Sun Kyu PARK, Gyeonggi-do (KR); Jae Hyoung KO, Gyeonggi-do (KR)

(21) Appl. No.: 18/961,446

(22) Filed: Nov. 27, 2024

(30) Foreign Application Priority Data
May 29, 2024 (KR) 10-2024-0070122

(51) Int. Cl. G06F 3/06

(52) U.S. Cl. CPC G06F 3/064; G06F 3/0604; G06F 3/0659; G06F 3/0673

(57) ABSTRACT

Provided herein may be a controller, a memory system including the controller, and a method of operating the memory system. The controller may include a programmed capacity table including information on a capacity of data programmed to memory blocks included in a memory device, a block selector configured to compare a capacity of data stored in a buffer memory with a reference capacity, and select, based on a result of a comparison, one of memory blocks designated as a free status block and or an open status block, among memory blocks, and a command generator configured to output a command for programming the data to the selected memory block.

### CROSS-REFERENCE TO RELATED APPLICATION

The present application claims priority under 35 U.S.C. § 119 (a) to Korean patent application number 10-2024-0070122 filed on May 29, 2024, the entire disclosure of which is incorporated by reference herein.

### BACKGROUND

### 1. Field of Invention

Various embodiments of the present disclosure generally relate to a controller, a memory system including the controller, and a method of operating the memory system, and more particularly to a controller configured to perform a program operation, a memory system including the controller, and a method of operating the memory system.

### 2. Description of Related Art

A memory system may include a storage device which stores data, and a controller which controls the storage device.

The storage device may include a plurality of memory blocks in which data is stored. Each of the memory blocks may include a plurality of memory cells. The capacity of data stored in memory blocks may vary depending on the memory blocks. A memory block having no programmed cells may be a free status block, a memory block having programmed cells and erased cells and being capable of storing further data may be an open status block, and a memory block in which no more data can be stored due to programmed cells may be a closed status block.

Since a programmed cell and an erased cell have different electrical potentials, the programmed cell and the erase cell may electrically interfere with each other when they are adjacent to each other. Therefore, during a read operation performed on the open status block, error data may be read. The number of pieces of error data may increase as the capacity of data stored in the open status block decreases.

### SUMMARY

Various embodiments of the present disclosure are directed to a controller that is capable of performing a program operation that enables the reliability of a memory system to be improved, a memory system including the controller, and a method of operating the memory system.

An embodiment of the present disclosure may provide for a controller. The controller may include a programmed capacity table including information on a capacity of data programmed to memory blocks included in a memory device, a block selector configured to compare a capacity of data stored in a buffer memory with a reference capacity, and select, based on a result of a comparison, one of memory blocks designated as a free status block and or an open status block, among memory blocks, and a command generator configured to output a command for programming the data to the selected memory block.

An embodiment of the present disclosure may provide for a memory system. The memory system may include a memory device including memory blocks, and a controller configured to control the memory device in response to a request from a host, wherein the controller is configured to compare a capacity of data transmitted from the host with a reference capacity, select, based on a result of a comparison, one of memory blocks designated as a free status block or an open status block, among the memory blocks, and program the data to the selected memory block.

An embodiment of the present disclosure may provide for a method of operating a memory system. The method may include designating each of memory blocks included in a memory device as a free status block or an open status block, comparing a capacity of data transmitted from a host with a reference capacity, selecting, based on a result of comparing the capacity of the data with the reference capacity, one of memory blocks designated as the free status block or the open status block, among the memory blocks, and programming the data to the selected memory block.

An embodiment of the present disclosure may provide for a method of operating a memory system. The method may include, selecting, when a capacity of data transmitted from a host is greater than a reference capacity, a memory block designated as a free status block, among memory blocks included in a memory device, and selecting, when the capacity of the data transmitted from the host is less than the reference capacity, a memory block designated as an open status block, among the memory blocks included in the memory device, and programming the data to the selected memory block.

### BRIEF DESCRIPTION OF THE DRAWINGS

FIGS. 1A and 1B are diagrams illustrating a memory system in accordance with embodiments of the present disclosure.

FIG. 2 is a diagram illustrating a memory device in accordance with an embodiment of the present disclosure.

FIG. 3 is a diagram illustrating a memory cell array in accordance with an embodiment of the present disclosure.

FIG. 4 is a diagram illustrating a memory block in accordance with an embodiment of the present disclosure.

FIG. 5 is a diagram illustrating the status of memory blocks in accordance with an embodiment of the present disclosure.

FIG. 6 is a diagram illustrating a controller in accordance with an embodiment of the present disclosure.

FIG. 7 is a diagram illustrating a method of operating a controller in accordance with an embodiment of the present disclosure.

FIG. 8 is a flowchart illustrating a method of operating a memory system in accordance with an embodiment of the present disclosure.

FIGS. 9A to 9C are diagrams illustrating an operating method when the capacity of data to be programmed is greater than a reference capacity, in accordance with an embodiment of the present disclosure.

FIGS. 10A and 10B are diagrams illustrating an operating method when a free status block is not present in a plane, in accordance with an embodiment of the present disclosure.

FIGS. 11A to 11C are diagrams illustrating an operating method when the capacity of data to be programmed is less than the reference capacity, in accordance with an embodiment of the present disclosure.

FIG. 12 is a diagram illustrating a memory card system including a controller according to an embodiment of the present disclosure.

FIG. 13 is a diagram illustrating a solid state drive (SSD) system including a controller according to an embodiment of the present disclosure.

### DETAILED DESCRIPTION

Specific structural or functional descriptions, disclosed herein, are illustrated to describe embodiments according to the concept of the present disclosure. The embodiments according to the concept of the present disclosure should not be construed as being limited to embodiments described below, and may be modified in various forms and replaced with other equivalent embodiments.

Hereinafter, although the terms “first” and “second” may be used herein to describe various elements, these elements should not be limited by these terms. The terms are used to distinguish one element from other elements.

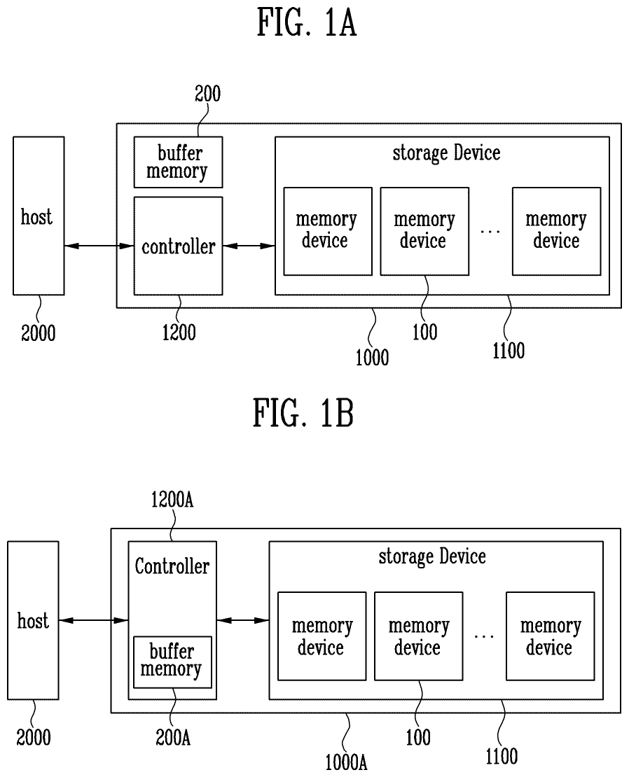

FIGS. 1A and 1B are diagrams illustrating an embodiment of a memory system in accordance with embodiments of the present disclosure.

Referring to FIG. 1A, a memory system 1000 may include a storage device 1100, a controller 1200, and a buffer memory 200.

The storage device 1100 may include a plurality of memory devices 100 which store data. Each of the memory devices 100 may be implemented using a volatile memory device or a nonvolatile memory device. The volatile memory device may be a device in which stored data is lost when power supply is interrupted. The nonvolatile memory device may be a device in which stored data is retained even when power supply is interrupted.

The controller 1200 may perform communication between a host 2000 and the storage device 1100. The controller 1200 may control the storage device 1100 in response to a request received from the host 2000.

The controller 1200 may temporarily store data output from the host 2000 in the buffer memory 200 and calculate the capacity of the data stored in the buffer memory 200 during a program operation. The controller 1200 may compare the capacity of the data stored in the buffer memory with a reference capacity, and may select a memory block included in the corresponding memory device 100 based on the result of the comparison. The reference capacity may be capacity preset in the controller 1200, and may be set to a value less than the total storage capacity of one memory block.

For example, when the capacity of the data stored in the buffer memory 200 is greater than the reference capacity, the controller 1200 may select a free status block from among the memory blocks included in the corresponding memory device 100, and may transmit a command, an address, and data to the memory device so that the program operation is performed on the selected memory block.

When the capacity of the data stored in the buffer memory 200 is less than the reference capacity, the controller 1200 may select an open status block from among the memory blocks included in the corresponding memory device 100, and may transmit a command, an address, and data to the memory device so that the program operation is performed on the selected memory block.

When the capacity of the data stored in the buffer memory 200 is equal to the reference capacity, the controller 1200 may be configured to select a free status block or an open status block from among the memory blocks included in the memory device 100.

The host 2000 may communicate with the storage device 1100 through the controller 1200 using an interface protocol such as peripheral component interconnect-express (PCI-E), advanced technology attachment (ATA), serial ATA (SATA), parallel ATA (PATA), or serial attached SCSI (SAS). Interface protocols between the host 2000 and the memory system 1000 are not limited to the above-described examples, and may include various interfaces, such as a universal serial bus (USB), a multi-media card (MMC), an enhanced small disk interface (ESDI), or integrated drive electronics (IDE).

The buffer memory 200 may temporarily store data DATA transmitted from the host 2000, and may output the stored data DATA to the storage device. The buffer memory 200 may be implemented using a volatile memory device or a nonvolatile memory device, or may be implemented using a volatile memory device and a nonvolatile memory device. Because the data storage and output speed of the volatile memory device is higher than that of the nonvolatile memory device, the volatile memory device may be more widely used as the buffer memory 200 than the nonvolatile memory device. For example, the buffer memory 200 may be implemented using at least one of a dynamic RAM (DRAM), a static RAM (SRAM), and a NAND flash memory. The buffer memory 200 may be used as a cache between the storage device 1100 and the controller 1200.

Referring to FIG. 1B, the memory system 1000A may include a storage device 1100 and a controller 1200A. The storage device 1100 may include a plurality of memory devices 100 which store data. In the drawing illustrated in FIG. 1B, a buffer memory 200A may be disposed inside the controller 1200A. Because the storage device 1100, the controller 1200A, the buffer memory 200A, and the memory devices 100 are described with reference to FIG. 1A, repeated descriptions thereof will be omitted.

When the buffer memory 200A is disposed inside the controller 1200A, the buffer memory 200A may be used as a cache or a tightly coupled memory (TCM).

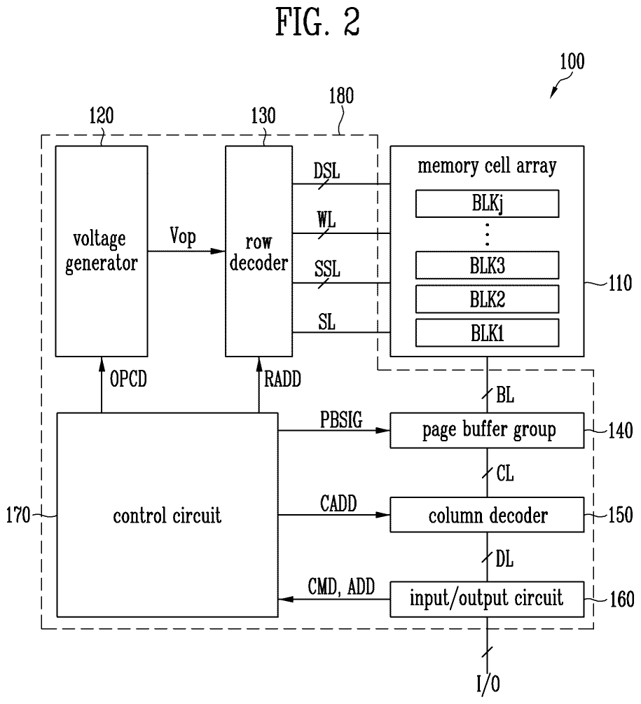

FIG. 2 is a diagram illustrating a memory device in accordance with an embodiment of the present disclosure.

Referring to FIG. 2, the memory device 100 may include a memory cell array 110 and a peripheral circuit 180.

The memory cell array 110 may include first to j-th memory blocks BLK1 to BLKj. Each of the first to j-th memory blocks BLK1 to BLKj may be formed to have a three-dimensional (3D) structure. Each of the first to j-th memory blocks BLK1 to BLKj formed to have the 3D structure may include memory cells stacked vertically on a substrate.

According to a program scheme, each memory cell may store 1 bit of data or 2 or more bits of data. For example, a scheme for storing 1 bit of data in one memory cell is referred to as a single-level cell (SLC) scheme, and a scheme for storing 2 bits of data in one memory cell is referred to as a multi-level cell (MLC) scheme. A scheme for storing 3 bits of data in one memory cell is referred to as a triple-level cell (TLC) scheme, and a scheme for storing 4 bits of data in one memory cell is referred to as a quad-level cell (QLC) scheme. In addition, 5 or more bits of data may be stored in one memory cell.

The peripheral circuit 180 may perform a program operation of storing data in the memory cell array 110, a read operation of outputting data stored in the memory cell array 110, and an erase operation of erasing data stored in the memory cell array 110. For example, the peripheral circuit 180 may include a voltage generator 120, a row decoder 130, a page buffer group 140, a column decoder 150, an input/output circuit 160, and a control circuit 170.

The voltage generator 120 may generate various operating voltages Vop that are used for a program operation, a read operation, or an erase operation in response to an operation code OPCD. For example, the voltage generator 120 may generate program voltages, pass voltages, turn-on voltages, turn-off voltages, a ground voltage, negative voltages, source voltages, verify voltages, read voltages, erase voltages, a precharge voltage, etc. in response to the operation code OPCD.

The program voltages may be voltages that are applied to a selected word line among the word lines WL during a program operation, and may be used to increase the threshold voltages of memory cells connected to the selected word line. The pass voltages may be voltages that are applied to unselected word lines among the word lines WL during a program or read operation, and may be used to turn on memory cells connected to unselected word lines. The turn-on voltages may be voltages that are applied to drain select lines DSL or source select lines SSL, and may be used to turn on drain select transistors or source select transistors. The turn-off voltages may be voltages that are applied to the drain select lines DSL or the source select lines SSL, and may be used to turn off the drain select transistors or the source select transistors. The ground voltage may be a voltage of 0 V, and the negative voltages may be voltages lower than 0 V. The source voltages may be a voltage that is applied to the source line SL, and may each be a negative voltage, a ground voltage or a positive voltage. The verify voltages may be voltages for determining the threshold voltages of selected memory cells during a program operation or an erase operation, and may be applied to the selected word line or all word lines connected to a selected memory block. The read voltages may be voltages that are applied to the selected word line during a read operation, and may be used to determine data stored in memory cells. The erase voltages may be voltages that are applied to the source line SL during an erase operation, and may be used to decrease the threshold voltages of the memory cells. The precharge voltage may be a positive voltage for precharging the channels of unselected strings during a verify or read operation, and may be supplied to the source line SL.

The row decoder 130 may be connected to the voltage generator 120 through global lines GL, and may be connected to the first to j-th memory blocks BLK1 to BLKj through the drain select lines DSL, the word lines WL, the source select lines SSL, and the source line SL. The row decoder 130 may transmit the operating voltages Vop to the drain select lines DSL, the word lines WL, the source select lines SSL, and the source line SL, which are connected to a memory block selected according to a row address RADD.

The page buffer group 140 may include page buffers (not illustrated) connected in common to the first to j-th memory blocks BLK1 to BLKj. For example, the page buffers (not illustrated) may be connected to the first to j-th memory blocks BLK1 to BLKj through the bit lines BL. The page buffers (not illustrated) may sense the currents or voltages of the bit lines BL in response to page buffer control signals PBSIG.

The column decoder 150 may be configured such that data is transferred between the page buffer group 140 and the input/output circuit 160 in response to a column address CADD. For example, the column decoder 150 may be connected to the page buffer group 140 through column lines CL, and may be connected to the input/output circuit 160 through data lines DL.

The input/output circuit 160 may receive or output a command CMD, an address ADD, or data through input/output lines I/O. For example, the input/output circuit 160 may transmit the command CMD and the address ADD, received from an external controller through the input/output lines I/O, to the control circuit 170, and may transmit the data, received from the external controller through the input/output lines I/O, to the column decoder 150. Alternatively, the input/output circuit 160 may output data, received from the column decoder 150, to the external controller through the input/output lines I/O.

The control circuit 170 may output the operation code OPCD, the row address RADD, the page buffer control signals PBSIG, and the column address CADD in response to the command CMD and the address ADD. For example, when the command CMD input to the control circuit 170 is a command corresponding to a program operation, the control circuit 170 may control the peripheral circuit 180 to perform the program operation on a memory block selected according to the address ADD. When the command CMD input to the control circuit 170 is a command corresponding to a read operation, the control circuit 170 may control the peripheral circuit 180 to perform the read operation on a memory block selected according to the address and output the read data. When the command CMD input to the control circuit 170 is a command corresponding to an erase operation, the control circuit 170 may control the peripheral circuit 180 to perform the erase operation on a selected memory block.

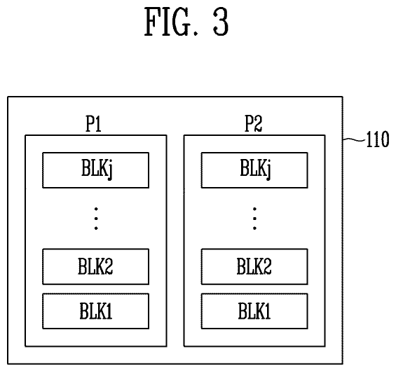

FIG. 3 is a diagram illustrating a memory cell array in accordance with an embodiment of the present disclosure.

Referring to FIG. 3, the memory cell array 110 may include a plurality of planes P1 and P2. Although, in FIG. 3, the first and second planes P1 and P2 are illustrated by way of example, the memory cell array 110 may include more planes than those illustrated in the drawing.

The first plane P1 and the second plane P2 may be connected to different source lines. The first plane P1 may include first to j-th memory blocks BLK1 to BLKj, and the second plane P2 may also include first to j-th memory blocks BLK1 to BLKj. Although the first and second planes P1 and P2 illustrated in FIG. 3 include the same number of memory blocks, the numbers of memory blocks may be different from each other according to an embodiment.

During a program operation, the first and second planes P1 and P2 may be simultaneously selected, and the first or second plane P1 or P2 may be selected. When the first and second planes P1 and P2 are simultaneously selected, a memory block selected from the first plane P1 and a memory block selected from the second plane P2 may be different from each other.

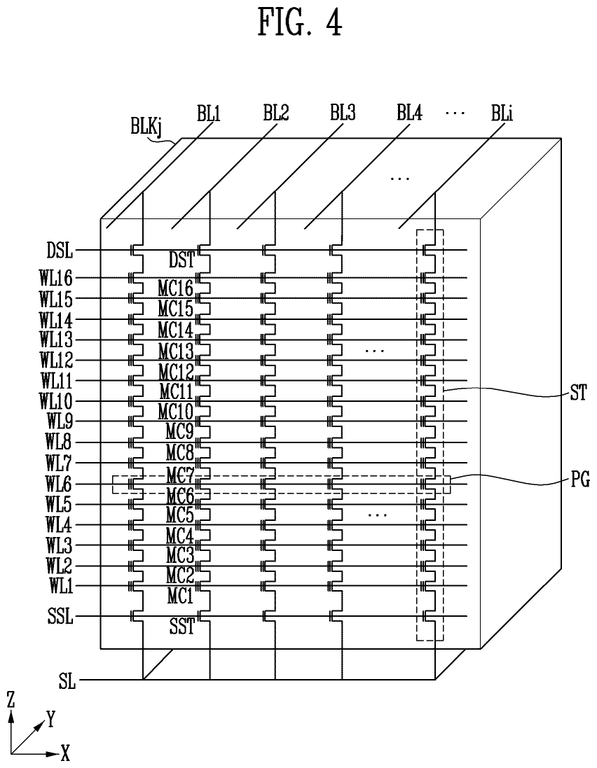

FIG. 4 is a diagram illustrating a memory block in accordance with an embodiment of the present disclosure.

Referring to FIG. 4, the j-th memory block BLKj, which is one of the first to j-th memory blocks BLK1 to BLKj, illustrated in FIG. 2, is illustrated by way of example.

The j-th memory block BLKj may include cell strings ST disposed between the source line SL and first to i-th bit lines BL1 to BLi. The cell strings ST may be arranged spaced apart from each other along X and Y directions, and each of the cell strings ST may extend in a Z direction. The first to i-th bit lines BL1 to BLi may be arranged spaced apart from each other along the X direction, and each of the first to i-th bit lines BL1 to BLi may extend along the Y direction. FIG. 4 is a diagram illustrating an embodiment of the j-th memory block BLKj, and thus the numbers of source select transistors SST, first to sixteenth memory cells MC1 to MC16, and drain select transistors DST, which are included in each of the cell strings ST, may vary depending on the memory device.

Gates of source select transistors SST included in different cell strings ST may be connected to a source select line SSL, gates of the first to sixteenth memory cells MC1 to MC16 may be connected to first to sixteenth word lines WL1 to WL16, and gates of drain select transistors DST may be connected to a drain select line DSL. The source select line SSL may be connected in common to the source select transistors SST arranged along the X and Y directions. Alternatively, a source select line SSL connected in common to the source select transistors SST arranged in the X direction and a source select line SSL connected in common to the source select transistors SST arranged in the Y direction may be separated from each other. The first to sixteenth word lines WL1 to WL16 may be connected in common to the memory cells arranged along the X and Y directions. For example, the first memory cells MC1 arranged along the X and Y directions may be connected in common to the first word line WL1, and the second memory cells MC2 arranged along the X and Y directions may be connected in common to the second word line WL2. The drain select line DSL may be connected in common to the drain select transistors DST arranged in the X direction. Different drain select lines DSL may be connected to the drain select transistors DST arranged in the Y direction.

A group of memory cells connected to the same word line may be a page (PG). A program or read operation may be performed on a page (PG) basis. For example, a group of memory cells connected to a selected word line among memory cells of the cell strings ST connected to a drain select line DSL, selected from among the drain select lines DSL, may be a selected page. The selected page may be a page composed of program target memory cells during a program operation. That is, the selected page may be determined by the drain select lines DSL and the corresponding word line.

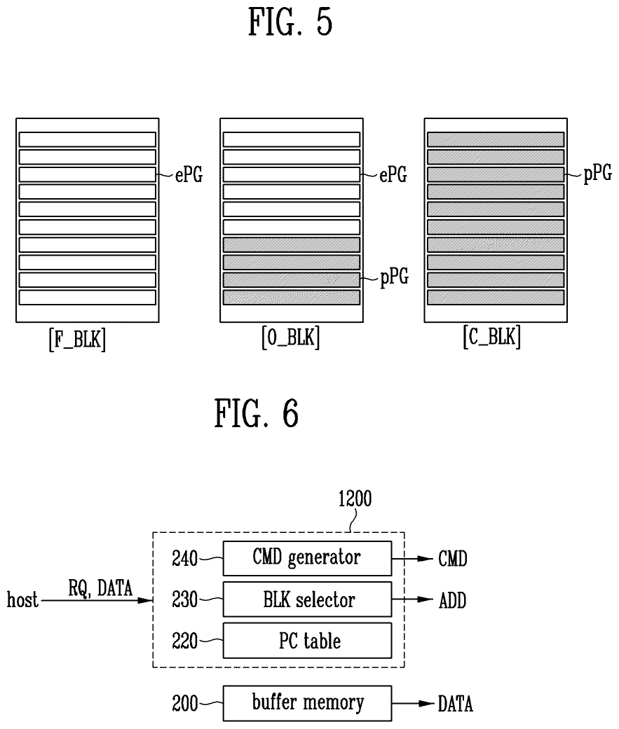

FIG. 5 is a diagram illustrating the status of memory blocks in accordance with an embodiment of the present disclosure.

Referring to FIG. 5, each memory block may be classified (or designated) as a free status block F_BLK, an open status block O_BLK, or a closed status block C_BLK depending on the status of the memory block. The status of the memory block may be changed depending on whether pages included in the memory block are programmed or erased.

The free status block F_BLK may be a block in which all pages included in the memory block are erased pages ePG, the open status block O_BLK may be a block including erased pages ePG and programmed pages pPG, and the closed status block C_BLK may be a block in which all pages are programmed pages pPG.

The free status block F_BLK and the open status block O_BLK may be blocks that can be programmed, and the closed status block C_BLK may be a block that cannot be programmed. When the free status block F_BLK or the open status block O_BLK is programmed and all pages become programmed pages pPG, the free status block F_BLK or the open status block O_BLK may be changed to the closed status block C_BLK. When the open status block O_BLK or the closed status block C_BLK is erased and all pages become erased pages ePG, the open status block O_BLK or the closed status block C_BLK may be changed to the free status block F_BLK.

Because programmed pages pPG are included in the open status block O_BLK and the closed status block C_BLK, a read operation of reading data stored in the open status block O_BLK or the closed status block C_BLK may be performed. When a read operation is first performed on a selected memory block included in the plane, the number of pieces of error data may increase in the read operation first performed on the selected memory block due to the influence of operations performed on memory blocks adjacent to the selected memory block. The reason for the increase in the number of pieces of error data is described as follows.

When an erase operation, a program operation or a read operation is performed on adjacent memory blocks, a positive voltage may be applied to channels of strings included in unselected memory blocks. When the positive voltage applied to the channels is not normally discharged, the number of pieces of error data may increase due to the positive voltage remaining in the channels during the read operation first performed on the corresponding memory block. Such read errors may increase as the number of programmed pages pPG included in the selected memory block decreases.

In this way, because the reliability of the read operation first performed on the selected memory block may be deteriorated, the same read operation may be repeated on the selected memory block. When the read operation is repeated, the channel potential of the selected memory block may be decreased to a normal level, and thus the number of pieces of error data may be reduced. However, because the same read operation is repeated, the time required for the read operation may increase.

The present embodiments provide a memory system and a method of operating the memory system, which may improve the reliability of a read operation by reducing the number of pieces of error data during a read operation first performed on a selected memory block.

FIG. 6 is a diagram illustrating a controller in accordance with an embodiment of the present disclosure.

Referring to FIG. 6, the controller 1200 may include a programmed capacity table (PC table) 220, a block (BLK) selector 230, and a command (CMD) generator 240. Although the controller 1200 that does not include a buffer memory 200 is illustrated in FIG. 6, the buffer memory 200 may be disposed inside the controller 1200, as described above with reference to FIG. 1B, depending on the memory system.

The buffer memory 200 may temporarily store data DATA output from the host 2000, and may output the stored data DATA to a storage device. Although the buffer memory 200 is implemented using a volatile memory device or a nonvolatile memory device, the data storage and output speed of the volatile memory device is higher than that of the nonvolatile memory device, and thus the volatile memory device may be more widely used as the buffer memory 200 than the nonvolatile memory device. For example, the buffer memory 200 may be implemented using at least one of a dynamic RAM (DRAM), a static RAM (SRAM), and a NAND flash memory. The buffer memory 200 may be used as a cache between the storage device 1100 and the controller 1200.

The programmed capacity table 220 may include the programmed capacity of each of the memory blocks. The programmed capacity may be the capacity of data programmed to the corresponding memory block, and may be stored in bytes or bits. Alternatively, the programmed capacity may be stored as a value obtained by calculating the capacity of data programmed to the corresponding memory block as a percentage. When the storage device is a NAND memory device, the programmed capacity may be a value obtained by converting the number of programmed pages among all pages included in the memory block into a percentage. For example, assuming that the total number of pages included in a first memory block is 100, the programmed capacity of the first memory block in which the number of programmed pages is 30 may be ‘30%’. For example, when no programmed page is present in a second memory block, the programmed capacity of the second memory block may be ‘0%’. For example, when all pages included in a third memory block are programmed pages, the programmed capacity of the third memory block may be ‘100%’. In this case, in the programmed capacity table 220, information corresponding to ‘30%’ that is the programmed capacity of the first memory block may be stored, information corresponding to ‘0%’ that is the programmed capacity of the second memory block may be stored, and information corresponding to ‘100%’ that is the programmed capacity of the third memory block may be stored. In addition, the programmed capacity may be stored as various values which can represent data programmed capacity relative to the total capacity of each memory block.

The block selector 230 may store a preset reference capacity, may select a memory block to which data stored in the buffer memory 200 is to be programmed, based on the capacity of data stored in the buffer memory 200, the programmed capacity of each of the memory blocks, stored in the programmed capacity table 220, and the reference capacity, and may output the address ADD of the selected memory block. The reference capacity prestored in the block selector 230 may be set to the specific capacity of data programmed to the memory block. For example, the reference capacity may be set based on the number of pieces of error data occurring during a read operation first performed on the programmed memory block. Since the number of pieces of error data may increase as the capacity of data programmed to the corresponding memory block decreases, the reference capacity may be set within a range from 10% to 50%. In an embodiment to be described below, the reference capacity is 50%.

The command generator 240 may generate and output a command CMD to be used to control the storage device in response to a request RQ received from the host 2000. For example, when a program request output from the host 2000 is received by the command generator 240, the command generator 240 may generate and output a program command.

The operations of the buffer memory 200, the programmed capacity table 220, and the block selector 230 among the above-described components will be described in detail below.

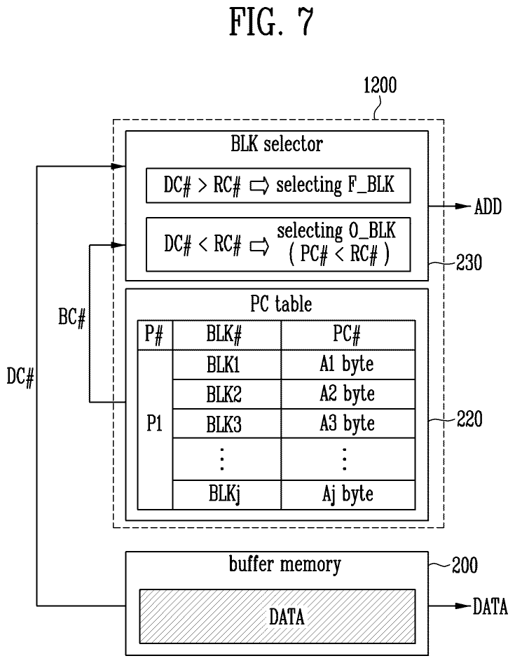

FIG. 7 is a diagram illustrating a method of operating a controller in accordance with an embodiment of the present disclosure.

Referring to FIG. 7, programmed capacity PC # of each of memory blocks BLK1 to BLKj included in a storage device may be stored in the programmed capacity table 220. When two or more planes are included in one memory device, programmed capacities PC # of the memory blocks BLK1 to BLKj may be stored for each plane P # in the programmed capacity table 220. In FIG. 7, an embodiment is illustrated in which respective programmed capacities PC # of first to j-th memory blocks BLK1 to BLKj included in the first plane P1 are stored. In an embodiment, the programmed capacity PC # of the first memory block BLK1 is A1 bytes, the programmed capacity PC # of the second memory block BLK2 is A2 bytes, the programmed capacity PC # of the third memory block BLK3 is A3 bytes, and the programmed capacity PC # of the j-th memory block BLKj is Aj bytes.

In FIG. 7, the A1 bytes is 10% of the total capacity of the first memory block BLK1, A2 bytes is 60% of the total capacity of the second memory block BLK2, A3 bytes is 0% of the total capacity of the third memory block BLK3, and Aj bytes is 100% of the total capacity of the j-th memory block BLKj. In this case, the first and second memory blocks BLK1 and BLK2 may be set as open status blocks O_BLK, the third memory block BLK3 may be set as a free status block F_BLK, and the j-th memory block BLKj may be set as a closed status block C_BLK. Whenever a program operation is performed in the memory device, the programmed capacity PC # of each memory block on which the program operation is performed may be updated, and the status O_BLK, F_BLK, or C_BLK of the memory blocks may be changed.

When data DATA output from the host 2000 is stored in the buffer memory 200, the block (BLK) selector 230 may calculate the capacity DC # of the input data DATA stored in the buffer memory 200.

The block selector 230 may compare the capacity DC # of the input data with reference capacity RC #.

When the capacity DC # of the input data is greater than the reference capacity RC #, the block selector 230 may select a memory block corresponding to the free status block F_BLK.

When the capacity DC # of the input data is less than the reference capacity RC #, the block selector 230 may select a memory block corresponding to the open status block O_BLK. For example, the address ADD of a memory block having programmed capacity PC # less than the reference capacity RC # among memory blocks corresponding to the open status block O_BLK in the same plane may be preferentially selected. When there is no memory block having programmed capacity PC # less than the reference capacity RC #, a memory block having the lowest programmed capacity PC # may be selected. When capacity in which data can be stored in the selected memory block is less than the capacity DC # of the data input to the buffer memory 200, two or more memory blocks corresponding to the open status block O_BLK may be selected. In this case, the data DATA may be divided and programmed into the two or more memory blocks.

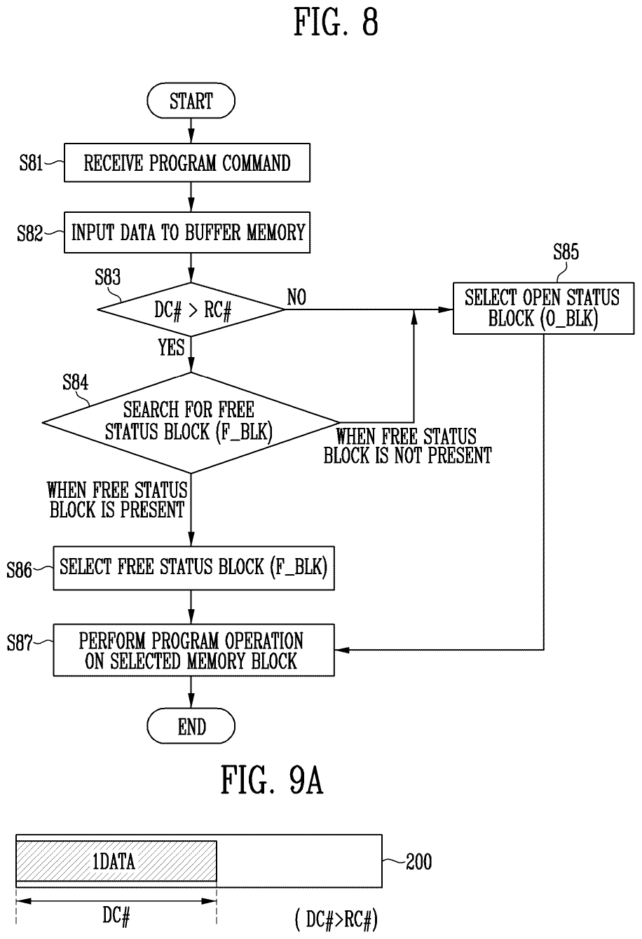

FIG. 8 is a flowchart illustrating a method of operating a memory system in accordance with an embodiment of the present disclosure.

Referring to FIGS. 7 and 8, when a program command output from the host 2000 is received by the memory system at operation S81, the memory system may input data output from the host 2000 to the buffer memory 200 of the memory system at operation S82.

The block selector 230 of the memory system may determine the capacity DC # of the data input to the buffer memory 200, and may compare the data capacity DC # with reference capacity RC # at operation S83. When it is determined at operation S83 that the capacity DC # of the input data is greater than the reference capacity RC #(in the case of “Yes”), the block selector 230 may search for a free status block F_BLK with reference to information stored in the programmed capacity table 220 at operation S84. When it is determined at the operation S83 that the capacity DC # of the input data is less than the reference capacity RC #(in the case of “No”), the block selector 230 may select an open status block O_BLK with reference to the information stored in the programmed capacity table 220 at operation S85. When the capacity DC # of the input data is equal to the reference capacity RC #, the operation S84 or S85 may be set to be performed.

At the operation S84, when the free status block F_BLK is found (i.e., when the free status block is present), the block selector 230 may select the free status block F_BLK at operation S86. At the operation S84, when no free status block F_BLK is found (i.e., when no free status block is present), the block selector 230 may select an open status block O_BLK at the operation S85.

When the memory block is selected at the operation S85 or S86, a program operation may be performed on a selected memory block at operation S87. For example, the command generator (e.g., 240 of FIG. 6) may output a command CMD for performing the program operation, the block selector 230 may output the address ADD of the selected memory block to the storage device, and the buffer memory 200 may transfer the data DATA stored therein to the storage device. The memory device included in the storage device may program the data DATA to the selected memory block in response to the command CMD and the address ADD output from the controller.

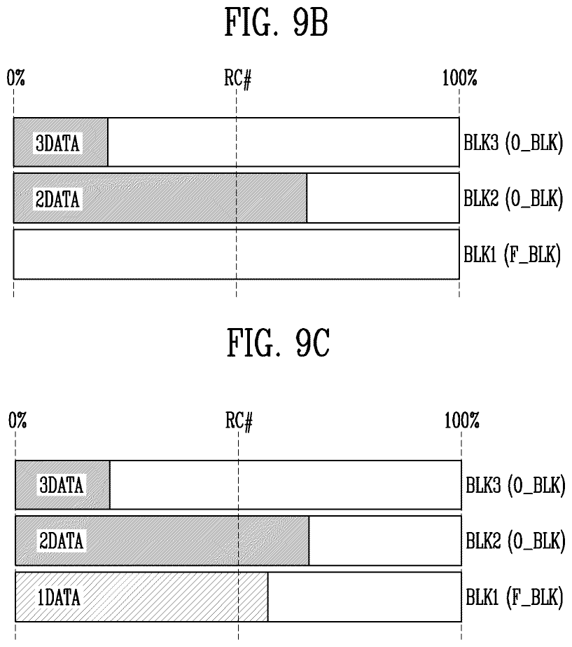

FIGS. 9A to 9C are diagrams illustrating an operating method when the capacity of data to be programmed is greater than reference capacity, in accordance with an embodiment of the present disclosure, and are diagrams for describing in detail the operations S83, S84, and S86 among the operations described above with reference to FIG. 8.

Referring to FIGS. 8 and 9A, data stored in the buffer memory 200 is first data 1DATA. The first data 1DATA may be data to be stored in the memory block. When the first data 1DATA is stored in the buffer memory 200, the block selector (e.g., 230 of FIG. 7) may determine the capacity DC # of the first data 1DATA stored in the buffer memory 220. FIGS. 9A to 9C illustrate the case where the capacity DC # of the first data 1DATA is greater than reference capacity RC # by way of example.

Referring to FIGS. 8 and 9B, the capacity DC # of the first data 1DATA is greater than the reference capacity RC #, and thus the block selector 230 may search for a free status block F_BLK based on the programmed capacity PC # of the programmed capacity table (e.g., 220 of FIG. 7). Among the memory blocks included in the memory device, first to third memory blocks BLK1 to BLK3 having different states will be described by way of example.

When the first memory block BLK1 is a free status block F_BLK having no programmed page, the second memory block BLK2 is an open status block O_BLK to which second data 2DATA is programmed, and the third memory block is an open status block O_BLK to which third data 3DATA is programmed, the block selector 230 may select the first memory block BLK1 that is the free status block F_BLK.

Referring to FIGS. 8 and 9C, the memory device may program the first data 1DATA to the first memory block BLK1 that is the free status block F_BLK under the control of the controller.

In a conventional scheme, the first data DATA1 may be programmed to the third memory block BLK3 that is the open status block O_BLK. However, in the present embodiment, when the capacity DC # of the first data 1DATA is greater than the reference capacity RC #, the first data 1DATA may be programmed to the first memory block BLK1 that is the free status block F_BLK to reduce the number of memory blocks corresponding to the free status block F_BLK. When the first data 1DATA is programmed to the first memory block BLK1, the first data 1DATA is programmed to pages, corresponding to the number of pages equal to or greater than the reference capacity RC #, among the pages in the first memory block BLK1, whereby the number of pieces of error data that may occur in a read operation first performed on the first memory block BLK1 may be reduced. Therefore, the number of iterations occurring in the read operation first performed on the first memory block may be reduced. Due thereto, the time required for the read operation of the memory device may be shortened.

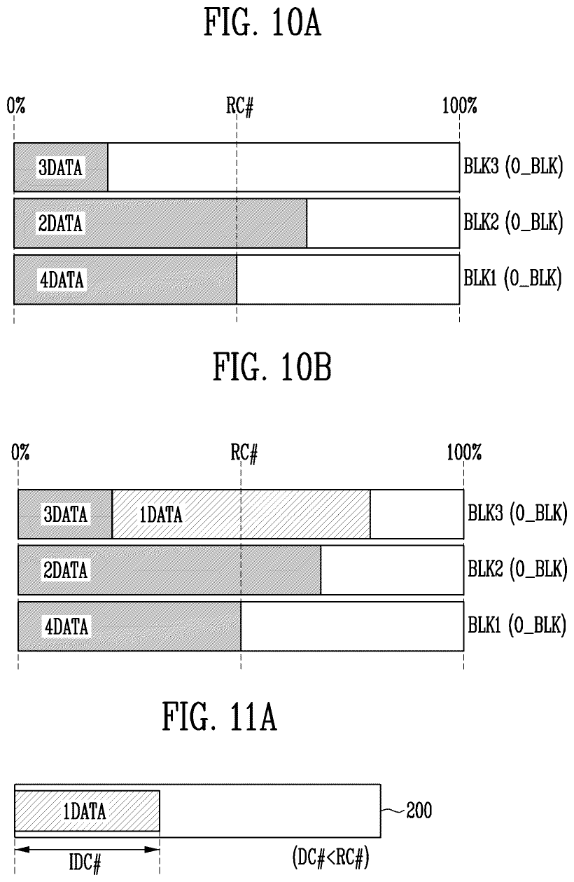

FIGS. 10A and 10B are diagrams illustrating an operating method when a free status block is not present in a plane, and are diagrams for describing in detail operations S84 and S85 among the operations described above with reference to FIG. 8, in accordance with an embodiment of the present disclosure.

Referring to FIGS. 8 and 10A, a free status block F_BLK may not be present among memory blocks included in the memory device. For example, in FIG. 10A the first memory block BLK1 is an open status block O_BLK to which fourth data 4DATA is programmed, the second memory block BLK2 is an open status block O_BLK to which second data 2DATA is programmed, and the third memory block BLK3 is an open status block O_BLK to which third data 3DATA is programmed. Since a free status block F_BLK is not present among the first to third memory blocks BLK1 to BLK3, but the first to third memory blocks BLK1 to BLK3 are open status blocks O_BLK, the block selector (e.g., 230 of FIG. 7) may select at least one memory block from among the first to third memory blocks BLK1 to BLK3. When the third memory block BLK3 has the largest available space, the third memory block BLK3 may be selected as a block to which the first data 1DATA is to be programmed. When a memory block having a sufficiently large available space to which all first data 1DATA can be programmed is not present among the open status blocks O_BLK, two or more open status blocks O_BLK may be selected.

Referring to FIGS. 8 and 10B, the memory device may program the first data 1DATA to the third memory block BLK3 under the control of the controller.

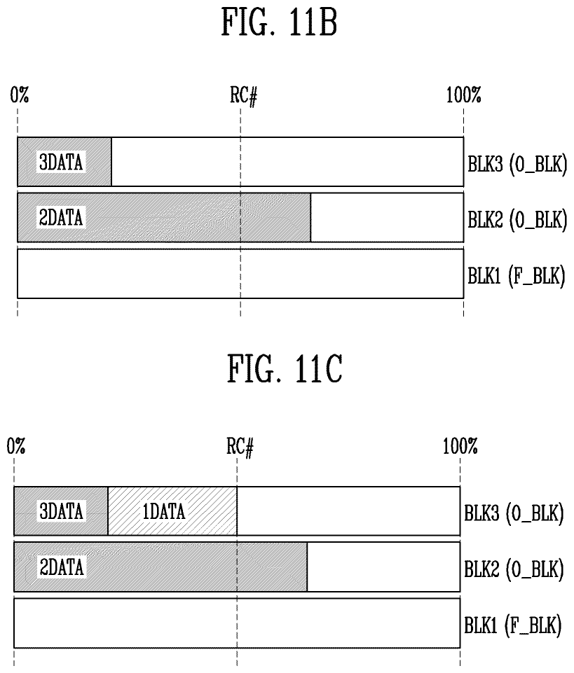

FIGS. 11A to 11C are diagrams illustrating an operating method when the capacity of data to be programmed is less than reference capacity, in accordance with an embodiment of the present disclosure, and are diagrams for describing in detail the operations S83 and S85 among the steps described above with reference to FIG. 8.

Referring to FIGS. 8 and 11A, data stored in the buffer memory 200 is first data 1DATA. The first data 1DATA may be data to be stored in the memory block. When the first data 1DATA is stored in the buffer memory 200, the block selector (e.g., 230 of FIG. 7) may determine the capacity DC # of the first data 1DATA stored in the buffer memory 220. In FIGS. 11A to 11C, the capacity DC # of the first data 1DATA is less than reference capacity RC #.

Referring to FIGS. 8 and 11B, the capacity DC # of the first data 1DATA is less than the reference capacity RC #, and thus the block selector 230 may select a free status block F_BLK based on the programmed capacity PC # of the programmed capacity table 220. Among the memory blocks included in the memory device, the first to third memory blocks BLK1 to BLK3 will be described by way of example.

In FIG. 11B, the first memory block BLK1 is a free status block F_BLK including no programmed page, the second memory block BLK2 is an open status block O_BLK to which second data 2DATA is programmed, and the third memory block is an open status block O_BLK to which third data 3DATA is programmed. In this case, the block selector 230 may select the third memory block BLK3 having larger capacity in which data can be stored between the second and third memory blocks BLK2 and BLK3 corresponding to the open status blocks O_BLK, without selecting the first memory block BLK1 that is the free status block F_BLK.

Referring to FIGS. 8 and 11C, the memory device may program the first data 1DATA to the third memory block BLK3 under the control of the controller.

When the first data 1DATA is programmed to the first memory block BLK1 rather than the third memory block BLK3, the number of pieces of error data that may occur during a read operation performed on the third memory block BLK3 to which the third data 3DATA is programmed may increase.

However, as in the case of the above-described embodiment, when the first data 1DATA is programmed to the third memory block BLK3, the programmed capacity of the third memory block BLK3 may increase, and thus the number of pieces of error data that may occur during the read operation first performed on the third memory block BLK3 may be reduced.

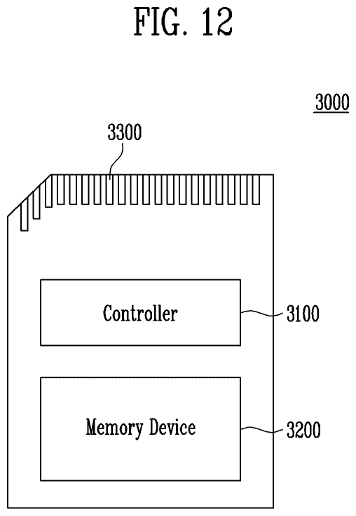

FIG. 12 is a diagram illustrating a memory card system including a controller according to an embodiment of the present disclosure.

Referring to FIG. 12, a memory card system 3000 includes a controller 3100, a memory device 3200, and a connector 3300.

The controller 3100 is connected to the memory device 3200. The controller 3100 may be configured in the same manner as the controller 1200 illustrated in FIG. 6. For example, the controller 3100 may include a programmed capacity table (e.g., 220 of FIG. 6), a block selector (e.g., 230 of FIG. 6), and a command generator (e.g., 240 of FIG. 6). The controller 3100 may program data to a free status block or an open status block among memory blocks included in the memory device 3200 depending on the capacity of data stored in a buffer memory. The controller 3100 may control a program operation, a read operation, or an erase operation of the memory device 3200 or control background operations of the memory device 3200. The controller 3100 may provide an interface between the memory device 3200 and a host (not shown). The controller 3100 may run firmware for controlling the memory device 3200. The controller 3100 may further include a processing unit, a host interface, a memory interface, and an error corrector. The controller 3100 may communicate with an external device through the connector 3300. The controller 3100 may communicate with an external device (e.g., a host) based on a specific communication standard. In an embodiment, the controller 3100 may communicate with the external device through at least one of various communication interfaces or standards such as universal serial bus (USB), multimedia card (MMC), embedded MMC (eMMC), peripheral component interconnection (PCI), PCI-express (PCI-E), an advanced technology attachment (ATA), serial-ATA (SATA), parallel-ATA (PATA), small computer system interface (SCSI), enhanced small disk interface (ESDI), integrated drive electronics (IDE), Firewire, universal flash storage (UFS), WiFi, Bluetooth, and nonvolatile memory express (NVMe). In an embodiment, the connector 3300 may be defined by at least one of the above-described various communication standards.

The memory device 3200 may include memory cells, and may be configured in the same manner as the memory device 100 illustrated in FIG. 2.

The controller 3100 and the memory device 3200 may be integrated into a single semiconductor device to form a memory card. For example, the controller 3100 and the memory device 3200 may be integrated into a single semiconductor device and may then form a memory card such as a PC card (personal computer memory card international association: PCMCIA), a compact flash card (CF), a smart media card (SM or SMC), a memory stick, a multimedia card (MMC, RS-MMC, MMCmicro or eMMC), a SD card (SD, miniSD, microSD, or SDHC), universal flash storage (UFS), or the like.

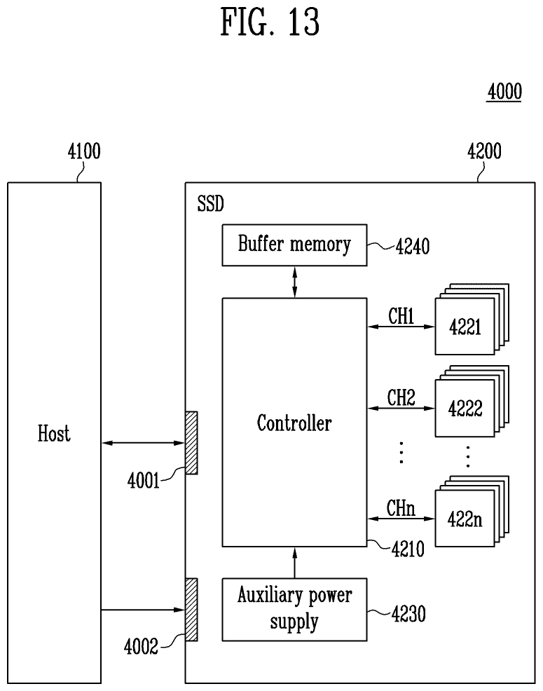

FIG. 13 is a diagram illustrating a solid state drive (SSD) system including a controller according to an embodiment of the present disclosure.

Referring to FIG. 13, an SSD system 4000 may include a host 4100 and an SSD 4200. The SSD 4200 may exchange signals with the host 4100 through a signal connector 4001, and may receive power through a power connector 4002. The SSD 4200 may include a controller 4210, a plurality of memory devices 4221 to 422n, an auxiliary power supply 4230, and a buffer memory 4240.

The controller 4210 may be configured in the same manner as the controller 1200 illustrated in FIG. 6. The controller 4210 may include a programmed capacity table (e.g., 220 of FIG. 6), a block selector (e.g., 230 of FIG. 6), and a command generator (e.g., 240 of FIG. 6). The controller 4210 may program data to a free status block or an open status block among memory blocks included in the plurality of memory devices 4221 to 422n depending on the capacity of data stored in a buffer memory. The controller 4210 may control the plurality of memory devices 4221 to 422n in response to signals received from the host 4100. In an embodiment, the signals may be signals based on the interfaces of the host 4100 and the SSD 4200. For example, the signals may be signals defined by at least one of communication interfaces or standards such as universal serial bus (USB), multimedia card (MMC), embedded MMC (eMMC), peripheral component interconnection (PCI), PCI-express (PCI-E), advanced technology attachment (ATA), serial-ATA (SATA), parallel-ATA (PATA), small computer system interface (SCSI), enhanced small disk interface (ESDI), integrated drive electronics (IDE), Firewire, universal flash storage (UFS), WiFi, Bluetooth, and nonvolatile memory express (NVMe).

Each of the plurality of memory devices 4221 to 422n may include cells in which data can be stored. Each of the plurality of memory devices 4221 to 422n may be configured in the same manner as the memory device 100 illustrated in FIG. 2.

The auxiliary power supply 4230 may be connected to the host 4100 through the power connector 4002. The auxiliary power supply 4230 may be supplied with a supply voltage from the host 4100, and may be charged. The auxiliary power supply 4230 may provide the supply voltage of the SSD 4200 when the supply of power from the host 4100 is not smoothly performed. In an embodiment, the auxiliary power supply 4230 may be located inside the SSD 4200 or located outside the SSD 4200. For example, the auxiliary power supply 4230 may be located on a main board, and may provide auxiliary power to the SSD 4200.

The buffer memory 4240 functions as a buffer memory of the SSD 4200. For example, the buffer memory 4240 may temporarily store data received from the host 4100 or data received from the plurality of memory devices 4221 to 422n or may temporarily store metadata (e.g., mapping tables) of the memory devices 4221 to 422n. The buffer memory 4240 may include volatile memories, such as DRAM, SDRAM, DDR SDRAM, and LPDDR SDRAM, or nonvolatile memories, such as FRAM, ReRAM, STT-MRAM, and PRAM.

According to embodiments of the present disclosure, the reliability of a memory system may be improved.

While embodiments of the present disclosure have been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all operations may be selectively performed or part of the operations may be omitted. In each embodiment, the operations are not necessarily performed in accordance with the described order and may be rearranged. The embodiments disclosed in this specification and drawings are only examples to facilitate an understanding of the present disclosure, and the embodiments of the present disclosure are not limited thereto. That is, it should be apparent to those skilled in the art that various modifications can be made based on the technological scope of the present disclosure.

The embodiments of the present disclosure have been described in the drawings and specification. Although specific terminologies are used here, those are only to describe the embodiments of the present disclosure. Therefore, the embodiments of the present disclosure are not restricted to the above-described embodiments and many variations are possible within the spirit and scope of the present disclosure. It should be apparent to those skilled in the art that various modifications can be made based on the technological scope of the present disclosure in addition to the embodiments disclosed herein. Furthermore, the embodiments may be combined to from additional embodiments.

What is claimed is:

1. A controller comprising:
a programmed capacity table including information on a capacity of data programmed to memory blocks included in a memory device;
a block selector configured to compare a capacity of data stored in a buffer memory with a reference capacity, and select, based on a result of a comparison, one of memory blocks designated as a free status block or an open status block, among memory blocks; and
a command generator configured to output a command for programming the data to the selected memory block.

2. The controller according to claim 1, wherein the buffer memory includes at least one of a dynamic RAM (DRAM), a static RAM (SRAM), and a NAND flash memory.

3. The controller according to claim 1, wherein the programmed capacity table includes information on a capacity of data programmed to each of the memory blocks.

4. The controller according to claim 1, wherein, when the capacity of the data is greater than the reference capacity and no memory block designated as the free status block is present among the memory blocks, the block selector is configured to select a memory block designated as the open status block.

5. The controller according to claim 1, wherein the reference capacity is set to a value less than a total capacity of one of the memory blocks.

6. The controller according to claim 1, wherein the block selector is configured to select a memory block having a relatively large programmable space from among the memory blocks designated as the open status block.

7. A memory system comprising:
a memory device including memory blocks; and
a controller configured to control the memory device in response to a request from a host,
wherein the controller is configured to
compare a capacity of data transmitted from the host with a reference capacity, and
select, based on a result of a comparison, one of memory blocks designated as a free status block or an open status block, among the memory blocks, and program the data to the selected memory block.

8. The memory system according to claim 7, wherein the reference capacity is set to a value less than a total capacity of one of the memory blocks included in the memory device.

9. The memory system according to claim 7, wherein the controller is configured to, when the capacity of the data is greater than the reference capacity, select one of the memory blocks designated as the free status block.

10. The memory system according to claim 7, wherein the controller is configured to, when the capacity of the data is less than the reference capacity, select one of the memory blocks designated as the open status block.

11. A method of operating a memory system, the method comprising:
designating each of memory blocks included in a memory device as a free status block or an open status block;
comparing a capacity of data transmitted from a host with a reference capacity;
selecting, based on a result of comparing the capacity of the data with the reference capacity, one of memory blocks designated as the free status block or the open status block, among the memory blocks; and
programming the data to the selected memory block.

12. The method according to claim 11, wherein the reference capacity is set to a value less than a total capacity of one of the memory blocks.

13. The method according to claim 11, wherein the selecting one of the memory blocks comprises:
selecting a memory block having a relatively large programmable space, among the memory blocks designated as the open status block.

14. The method according to claim 11, wherein the selecting one of the memory blocks comprises:
selecting, when the capacity of the data is greater than the reference capacity, one of the memory blocks designated as the free status block.

15. The method according to claim 11, wherein the selecting one of the memory blocks comprises:
selecting, when the capacity of the data is less than the reference capacity, one of the memory blocks designated as the open status block.

16. A method of operating a memory system, the method comprising:
selecting, when a capacity of data transmitted from a host is greater than a reference capacity, a memory block designated as a free status block, among memory blocks included in a memory device; and
selecting, when the capacity of the data transmitted from the host is less than the reference capacity, a memory block designated as an open status block, among the memory blocks included in the memory device; and
programming the data to the selected memory block.

17. The method according to claim 16, wherein the reference capacity is set to a value less than a total capacity of one of the memory blocks.
